(19) United States
(12) Patent Application Publication
(10) Pub. No.: US 2012/0326679 A1
(43) Pub. Date: Dec. 27, 2012

(54) DEVICE FOR OPTIMIZING ENERGY USAGE IN MULTIPHASE AC POWER SOURCE

(76) Inventor: JAMES LAU, Tustin, CA (US)

(21) Appl. No.: 13/529,944

(22) Filed: Jun. 21, 2012

Related U.S. Application Data
(60) Provisional application No. 61/501,523, filed on Jun. 27, 2011.

(51) Int. Cl. G05F 1/70

(52) U.S. Cl. 323/208

(57) ABSTRACT

An energy optimization alternating current power balancing system for a three phase alternating current power source using various configurations of chokes, wire inductors and capacitors connected across and in parallel to each power lines from the alternating current power source. An inductor in the alternating current power-balancing device or system is connected in series to the neutral line of the alternating current power source to create a more balanced power distribution system by improving the power factor and increasing the efficiency of energy consumption in multiphase alternating current power source.

### BACKGROUND OF THE DISCLOSURE

This application claims the benefit of U.S. Provisional Application No. 61/501,523 filed on Jun. 27, 2011.

### TECHNICAL FIELD OF THE DISCLOSURE

This embodiment relates in general to devices for optimizing energy usage in multiphase AC power sources. More particularly, the device is an energy reduction and power factor improvement apparatus to be installed in a utility grid to save electrical energy.

### DESCRIPTION OF THE RELATED ART

Various energy savings devices are currently available for use in electrical systems. Conventional energy saving devices, sometimes called power conditioners, normally contain complex, bulky circuitry and are costly to produce and install. Conventional AC energy saving device designed for AC power lines can be used with both single-phase and three-phase power supply. The AC power conditioning unit contains capacitors, transient suppressors and chokes across power lines, or across a power line and the neutral line of a power source. This device also uses the connection paths of the choke in series with a capacitor from each power line to the neutral line. Two chokes and two capacitors are used on each pair of power lines. Even though the device provides greater operating efficiency, transient suppression and power factor correction, the number of chokes and capacitors required to provide the energy saving operation is makes the device very bulky and increases the overall cost of the power conditioner equipment and its installation.

The energy saving methods and apparatuses conventionally used in a power grid also include inverters installed in industrial facilities to reduce electric power consumption. The conventional apparatus contains a supervisory unit for supervising the operational status of a supervised load facility containing an inverter, a means for sending the operational data through a communication system, an apparatus for calculating the saved electrical power consumption, and a processor for performing a billing operation based on a merit refund under the contract conditions established between the energy saving service provider and its contractor. The initial investment in purchasing the inverter is typically quite large.

Some energy saving devices reduces power loss by altering the sinusoidal shape of the voltage obtained from the power grid. This energy savings device includes a power supply with an internal dc battery. An external ac source supplies sinusoidal voltage, which is rectified and applied to a load under the control of a transistor. The internal dc battery compensates for fluctuations of the ac power source and is maintained in a fully charged condition. This device is intended to be connected between the utility power metering device and the residential circuit breaker box. A shortcoming associated with the operation of the energy savings device is that, while the power supply is designed to maintain a constant voltage load, the power supply introduces additional power losses and is not able to cope with the varying demands of ac loads, leading to an inefficient supply of energy. In addition a switching power supply is used for converting an input voltage to a different output voltage to save energy. This makes the device bulky and increases the potential of damage to frequency-specific devices such as induction motors and computers.

Therefore there exists a need for a less complex, more compact and easily manufactured device which may be readily inserted into a single or multiple phase AC circuit to reduce the power consumption of the attached electrical components. Such a device would not affect the normal operation of different electrical components attached to the circuit; and would not allow a change in output frequency to prevent the possibility of malfunction or damage to the attached electrical components. Such a device would incorporate the means for real-time monitoring of circuit parameters and energy consumption; ensure the flow of balanced currents through each phase of a three phase circuit in which it is inserted; and constantly adjust to any changes in the circuit load. Additionally such a device would be capable of not only providing energy savings, but also provide a means for power factor correction in AC circuits to prevent inefficiencies common to inductive loads. The current embodiment accomplishes these objectives.

### SUMMARY OF THE INVENTION

To minimize the limitations found in the prior art, and to minimize other limitations that will be apparent upon the reading of the specifications, preferred embodiment of the present invention provides an alternating current power balancing system.

In accordance of the preferred embodiment, the present invention is an alternating current power balancing system for a three phase alternating current power source. This alternating current power-balancing system saves some energy by improving the power factor and forces equal amount of current flow in each of the power lines, thereby providing a balanced system, when connected to a three phase alternating current power source such as the utility grid. Without the use of alternating current power-balancing system, the current flow in each of the power line is unequal and the system is not balanced. This unequal current flow is not optimum and causes wastage of electrical energy.

The present invention provides a system for reducing electrical energy consumption by improving the power factor and by improving energy storage among power lines from an alternating current power source having a three phase three wire delta connection or a three phase four wire star connection. A more balanced amount of current is made to flow from an alternating current power source into each of the three phase line thereby reducing the total amount of the three phase currents consumed by the load thus saving energy. In addition, a more balanced current in each of the three phase power lines reduces the amount of current flowing back to the alternating current power source through the neutral line. Current flowing on the neutral line is due to imbalance of current on each of the three power lines. The current on the neutral line flowing back to the alternating current power source represents a power loss and wastage of energy to the user. Together with the use of capacitors across each power lines, power factor is improved and some energy is saved.

The present invention is an alternating current power balancing device or system consisting of capacitors, inductors, coils, switches, chokes and other electronics to cause a more balanced current flow on each of the alternating current power sources' three power lines when the loads are inductive in nature. The circuit in the alternating current power-balancing device or system is connected across and in parallel to each power lines from the alternating current power source and an inductor in the alternating current power-balancing device or system is series connected to the neutral line of the alternating current power source. Thus the alternating current power source provides a reduced and more balanced amount of current flow in each of the three phase lines, and a reduced amount of current flow on the neutral line. The alternating current power source saves wastage of energy, improves the power factor and creates a more efficient way of power distribution from an alternating current power source having a three phase delta or a three phase four wire star connection with a neutral line.

An alternate embodiment of the invention provides a circuit without the use of an inductor on the neutral line.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 is a schematic diagram showing an alternating current power balancing system connected to a three phase four wire line, extending from an alternating current power source, with a choke in series to a neutral line, and a wire inductor in each phase, in accordance with the preferred embodiment of the present invention.

FIG. 2 is a schematic diagram showing the alternating current power balancing system connected to a three phase delta connected lines extending from an alternating current power source with each of the wire inductor in each phase, in accordance with another embodiment of the present invention.

FIG. 3 is a schematic diagram showing the alternating current power balancing system connected to the three phase four wire line, extending from an alternating current power source, with a choke in series in the neutral line and a pair of wire inductors in each phase, in accordance with another embodiment of the present invention.

FIG. 4 is a schematic diagram showing the alternating current power balancing system connected to the three phase four wire line, extending from an alternating current power source, with a choke in series with the neutral line and a wire inductor before the choke and a wire inductor after the choke in each phase, in accordance with another embodiment of the present invention.

FIG. 5 is a schematic diagram showing the alternating current power balancing system connected to the three phase four wire line, extending from an alternating current power source, with a choke in series with the neutral line and each phase and wires from two phase passed through the inductor coil of a third wire, and alternating among all the three phases.

FIG. 6 is a schematic diagram showing the alternating current power balancing system connected to the three phase four wire line, extending from an alternating current power source, with a choke in series with the neutral line, and the neutral line passed through a wire inductor in each of the phases, in accordance with another embodiment of the present invention.

FIG. 7 shows a phasor diagram showing phase angles between voltages and currents in each phase of the three phase system without installing the alternating current power balancing system in the utility grid.

FIG. 8 shows the phasor diagram showing the phase angle between voltages and currents in each phase of the three phase system with the alternating current power balancing system installed in the utility grid.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

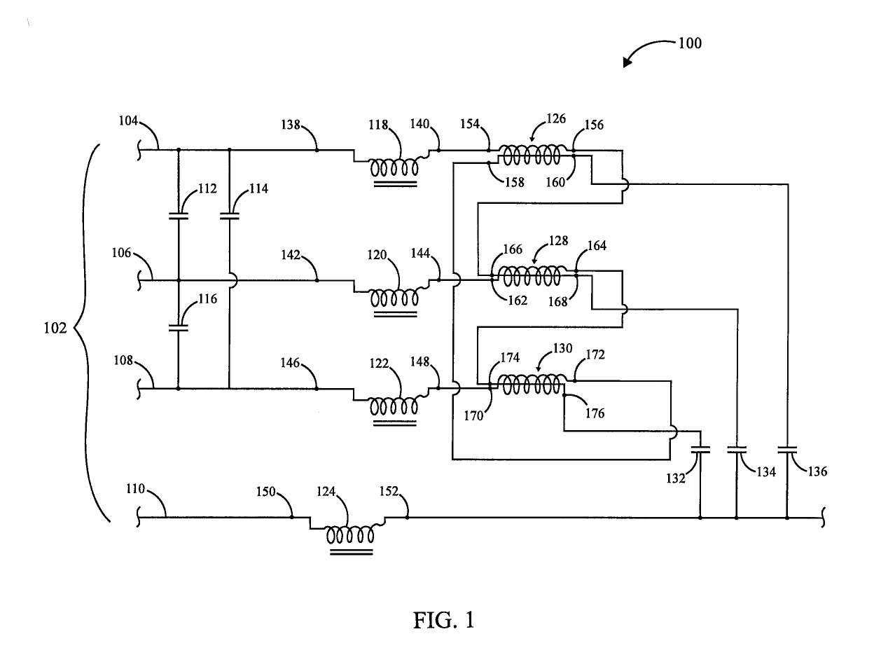

FIG. 1 is a schematic diagram showing an alternating current power balancing system 100 connected to a three phase four wire line 102, extending from an alternating current power source (not shown). The alternating current power source is an electric utility grid. The three phase four wire line 102 has a first power line 104, a second power line 106, a third power line 108, and a neutral line 110 connected to and drawn from the electric utility grid. The first power line 104, the second power line 106, and the third power line 108 are parallel and are connected to first phase, second phase and third phase of the alternating current power source. The neutral line 110 is serially or parallelly connected to the neutral line of the alternating current power source. A first coupling capacitor 112 is connected across the first power line 104 and the second power line 106, a second coupling capacitor 114 across the first power line 104 and the third power line 108, and a third coupling capacitor 116 across the second power line 106 and the third power line 108.

The circuit includes a plurality of chokes, which is a two terminal device. Current can flow in either direction. A first choke 118 is connected in series to the first power line 104, a second choke 120 is connected in series to the second power line 106, a third choke 122 is connected in series to the third power line 108 and a forth choke 124 is connected in series to the neutral line 110 of the alternating current power source.

A plurality of wire inductors is installed in the alternating current power balancing system. Each of the plurality of wire inductors, the plurality of wire inductors includes a first wire inductor 126, a second wire inductor 128 and a third wire inductor 130, each having four terminals. The four terminals include a first input terminal, a second input terminal, a first output terminal and a second output terminal. The wire inductor is a four terminal device. The wire inductor has a winding wire wrapped tightly around an electrically isolated stand alone straight wire. The first end of the winding is the first input terminal and the second end of the winding is the first output terminal. The first end of the straight wire is the second input terminal and the second end of the straight wire is the second output terminal with proper winding polarity. Three wire inductors namely a first wire inductor 126, a second wire inductor 128 and a third wire inductor 130 is present in the alternating current power balancing system. The first wire inductor 126 is associated with the first power line 104, the second wire inductor 128 is associated with the second power line 106 and the third wire inductor 130 is associated with the third power line 108. Current can flow in and out of any direction on the two wires of the wire inductors. A plurality of capacitors is connected between at least one of the second output terminals of the plurality of wire inductors and the neutral line 110.

The alternating current power balancing system for the three phase four wire line 102 is explained by means of four main connection paths including a first path, a second path, a third path and a fourth path.

The first path is, the first power line 104 from a parallel connection to phase one of the utility grid, and is connected to a first terminal 138 of the first choke 118, a second terminal 140 of the first choke 118 is connected to a first input terminal 154 of the first wire inductor 126 and a first output terminal 156 of the first wire inductor 126 is connected to a second input terminal 166 of the second wire inductor 128. A second output terminal 160 of the first wire inductor 126 is connected to a first terminal of a third capacitor 136 and a second terminal of the third capacitor 136 is connected to the neutral line 110 to which a second terminal 152 of the fourth choke 124 is connected. A first terminal 150 of the fourth choke 124 is connected to the neutral line 110 of utility grid.

The second path is, the second power line 106 from a parallel connection to phase two of the utility grid, and is connected to a first terminal 142 of the second choke 120, a second terminal 144 of the second choke 120 is connected to a first input terminal 162 of the second wire inductor 128 and a first output terminal 164 is connected to a second input terminal 174 of the third wire inductor 130. A second output terminal 168 of the second wire inductor 128 is connected to a first terminal of a second capacitor 134 and a second terminal of the second capacitor 134 is connected to the neutral line 110 to which the second terminal 152 of the fourth choke 124 is connected. The first terminal 150 of the fourth choke 124 is connected to the neutral line 110 of utility grid.

The third path is, the third power line 108 from a parallel connection to phase three of the utility grid and is connected to a first terminal 146 of the third choke 122 and a second terminal 148 of the third choke 122 is connected to a first input terminal 170 of the third wire inductor 130 and a first output terminal 172 is connected to a second input terminal 158 of the first wire inductor 126. A second output terminal 176 of the third wire inductor 130 is connected to a first terminal of a first capacitor 132 and a second terminal of the first capacitor 132 is connected to the neutral line 110 to which the second terminal 152 of the fourth choke 124 is connected. The first terminal 150 of the fourth choke 124 is connected to the neutral line 110 of utility grid.

The fourth path is a series connection from the neutral line 110 of the utility grid, the first terminal 150 of the fourth choke 124 and the second terminal 152 of the fourth choke 124 is connected to the neutral line 110 of the rest of the loads.

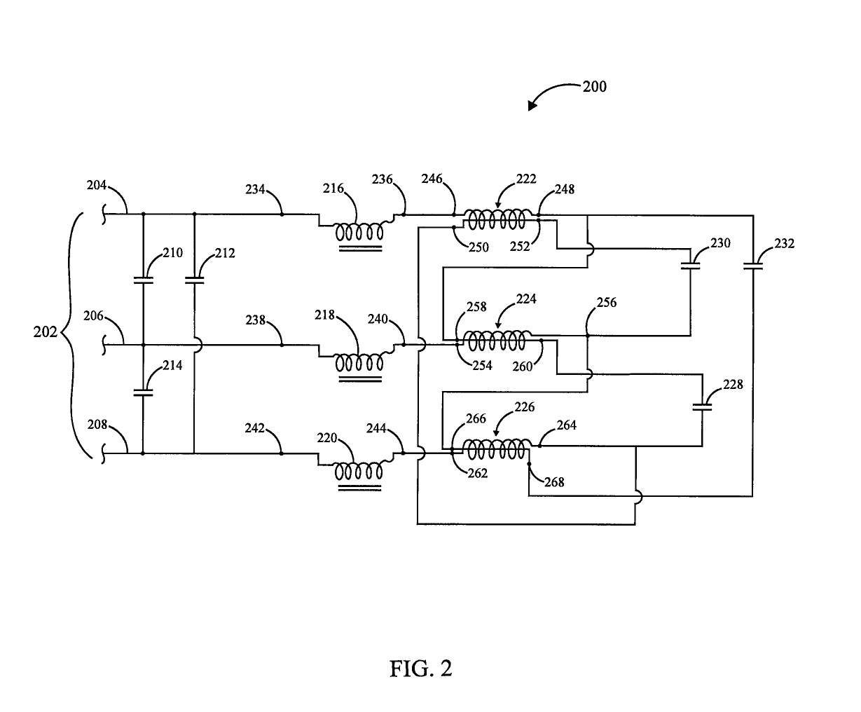

Referring to FIG. 2, another embodiments of the alternating current power balancing system 200 is explained with the help of three main connection paths including a first path, a second path and a third path.

FIG. 2 is a schematic diagram showing the alternating current power balancing system 200 connected to a three phase delta connected system. The three phase delta connected system has a first power line 204, a second power line 206 and a third power line 208 connected to and drawn from the electric utility grid. The first power line 204, the second power line 206, and the third power line 208 are parallel and are connected to first phase, second phase and third phase of the alternating current power source. A plurality of coupling capacitors for power factor improvement is included in the system. A first coupling capacitor 210 is connected across the first power line 204 and the second power line 206, a second coupling capacitor 212 across the first power line 204 and the third power line 208, and a third coupling capacitor 214 is connected across the second power line 206 and the third power line 208.

First path is, the first power line 204 connected to a first terminal 234 of a first choke 216 and a second terminal 236 of the first choke 216 is connected to a first input terminal 246 of a first wire inductor 222. Then, a first output terminal 248 of the first wire inductor 222 is connected to a second input terminal 258 of a second wire inductor 224. Then, a second output terminal 260 of the second wire inductor 224 is connected to a first terminal of the first capacitor 228 and a second terminal of the first capacitor 228 is connected to a first output terminal 264 of a third wire inductor 226.

Second path is, the second power line 206 connected to a first terminal 238 of a second choke 218 and a second terminal 240 of the second choke 218 is connected to a first input terminal 254 of the second wire inductor 224. Then a first output terminal 256 is connected to a second input terminal 266 of the third wire inductor 226. Then a second output terminal 268 of the third wire inductor 226 is connected to a third capacitor 232, the third capacitor 232 is connected to the first output terminal 248 of the first wire inductor 222. The second capacitor 230 is connected to a second output terminal 252 of the first wire inductor 222 and the second capacitor 230 is connected to the first output terminal 256 of the second wire inductor 224.

Third path is, the third power line 208 connected to a first terminal 242 of a third choke 220 and a second terminal 244 of the third choke 220 is connected to a first input terminal 262 of the third wire inductor 226. Then, a first output terminal 264 of the third wire inductor 226 is connected to a first terminal of a first capacitor 228 and then a second terminal of the first capacitor 228 is connected to a second output terminal 260 of the second wire inductor 224.

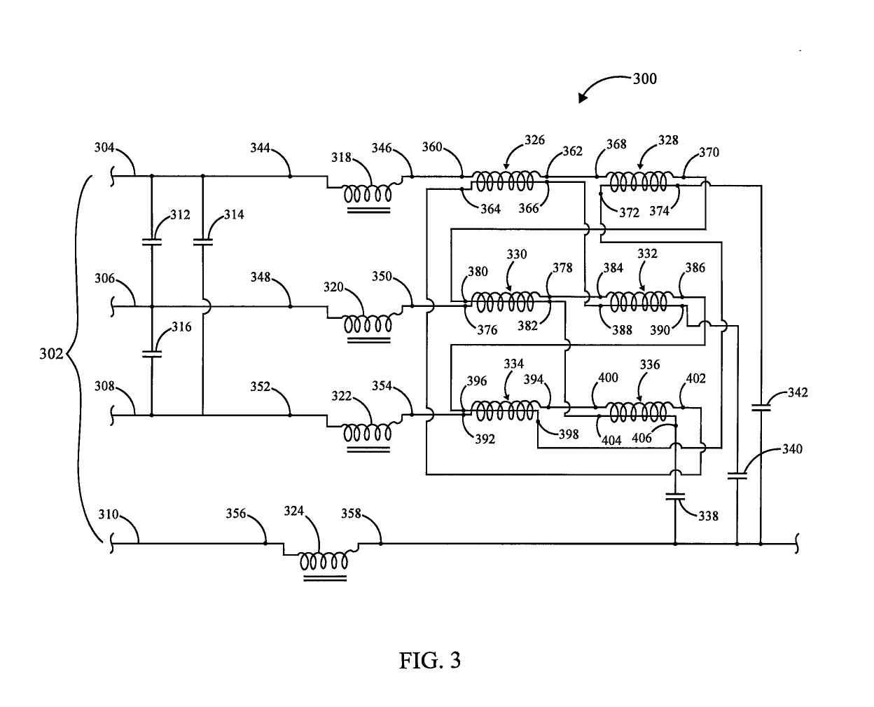

FIG. 3 is a schematic diagram showing the alternating current power balancing system 300 connected to a three phase four wire line 302. FIG. 3 is a better circuit and can achieve a more equal sharing of current flowing in each power lines. This circuit uses two wire inductors, one AC choke, and one capacitor per power line, and one coupling capacitor for power factor improvement, each across each of the power lines.

A first coupling capacitor 312 connects across a first power line 304 and a second power line 306. A second coupling capacitor 314 connects across the first power line 304 and a third power line 308 and a third coupling capacitor 316 connects across the third power line 308 and the second power line 306.

First path is, the first power line 304 connected to a first terminal 344 of a first choke 318 and a second terminal 346 of the first choke 318 is connected to a first input terminal 360 of a first wire inductor 326. Then, a first output terminal 362 of the first wire inductor 326 is connected to a first input terminal 368 of a second wire inductor 328, and a first output terminal 370 of the second wire inductor 328 is connected to a second input terminal 380 of a third wire inductor 330, and a second output terminal 382 of the third wire inductor 330 is connected to a second input terminal of 404 of a sixth wire inductor 336 and a second output terminal 406 is connected to a first terminal of a first capacitor 338 and a second terminal of the first capacitor 338 is connected to a second terminal 358 of a fourth choke 324 and a first terminal 356 of the fourth choke 324 is connected to a neutral line 310 of utility grid.

Second path is, the second power line 306 connected to a first terminal 348 of a second choke 320 and a second terminal 350 of the second choke 320 is connected to a first input terminal 376 of the third wire inductor 330. Then, a first output terminal 378 of the third wire inductor 330 is connected to a first input terminal 384 of a fourth wire inductor 332, and a first output terminal 386 is connected to a second input terminal 396 of a fifth wire inductor 334, and a second output terminal 398 of the fifth wire inductor 334 is connected to a second input terminal 372 of the second wire inductor 328 and a second output terminal 374 is connected to a first terminal of a third capacitor 342 and a second terminal of the third capacitor 342 is connected to the second terminal 358 of the fourth choke 324.

Third path is, the third power line 308 connected to a first input terminal 352 of a third choke 322 and a second terminal 354 of the third choke 322 is connected to a first input terminal 392 of the fifth wire inductor 334. Then, a first output terminal 394 of the fifth wire inductor 334 is connected to a first input terminal 400 of the sixth wire inductor 336, and a first output terminal 402 of the sixth wire inductor 336 is connected to a second input terminal 364 of the first wire inductor 326, and a second output terminal 366 of the first wire inductor 326 is connected to a second input terminal 388 of the fourth wire inductor 332 and a second output terminal 390 is connected to a first terminal of a second capacitor 340 and a second terminal of the second capacitor 340 is connected to the second terminal 358 of the fourth choke 324.

Fourth path is a series connection from the neutral line 310 of the utility grid to the first terminal 356 of the fourth choke 324, and the second terminal 358 of the fourth choke 324 is connected to the neutral line 310 of the rest of the loads.

This embodiment allows cross regulations of each of the three power lines among its two neighboring power lines to cause the current to balance among the three power lines with small current on the neutral line 310 flowing back to the utility grid.

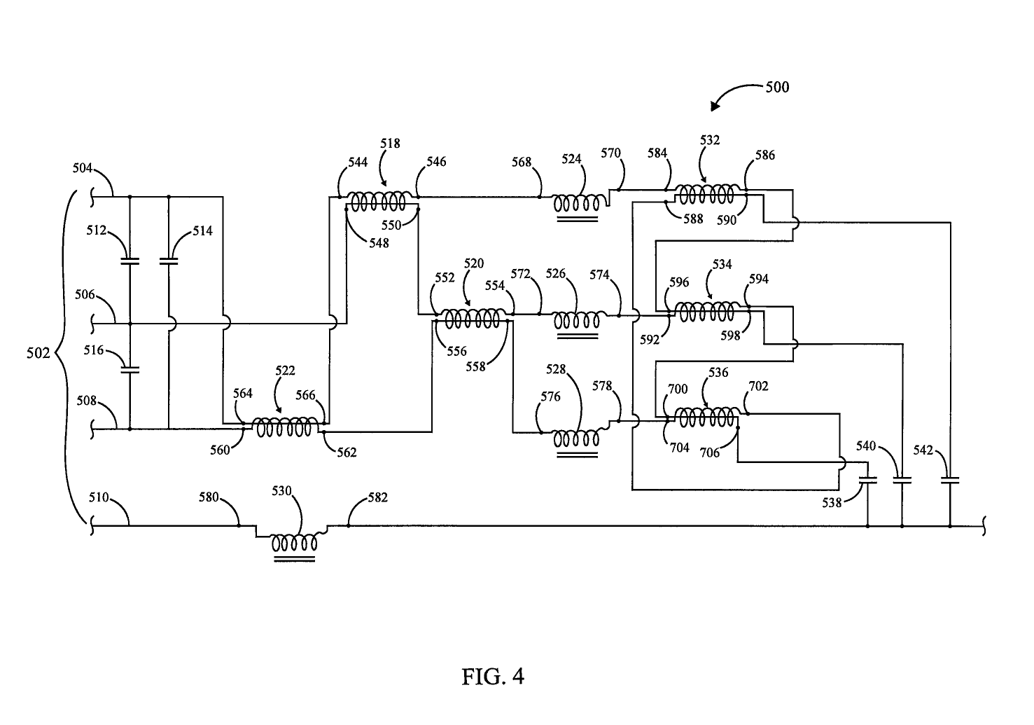

FIG. 4 is a schematic showing an alternate configuration to FIG. 3, where the first cross regulation sets of connections is done prior to the chokes connection.

A first coupling capacitor 512 is connected across a first power line 504 and a second power line 506. A second coupling capacitor 514 connects across the first power line 504 and a third power line 508 and a third coupling capacitor 516 connects across the third power line 508 and the second power line 506.

First path is, the first power line 504 connected to a second input terminal 564 of a third wire inductor 522 and a second output terminal 566 of the third wire inductor 522 is connected to a first input terminal 544 of a first wire inductor 518 and a first output terminal 546 of the first wire inductor 518 is connected to a first terminal 568 of a first choke 524, a second terminal 570 of the first choke 524 is connected to a first input terminal 584 of a fourth wire inductor 532 and a first output terminal 586 of the fourth wire inductor 532 is connected to a second input terminal 596 of a fifth wire inductor 534. A second output terminal 590 of the fourth wire inductor 532 is connected to a first terminal of a third capacitor 542 and a second terminal of the third capacitor 542 is connected to a neutral line 510 to which a second terminal 582 of a fourth choke 530 is connected. A first terminal 580 of the fourth choke 530 is connected to the neutral line 510 of utility grid.

Second path is, a second power line 506 connected to a second input terminal 548 of the first wire inductor 518 and a second output terminal 550 of the first wire inductor 518 is connected to a first input terminal 552 of a second wire inductor 520 and a first output terminal 554 of the second wire inductor 520 is connected to a first terminal 572 of a second choke 526, a second terminal 574 of the second choke 526 is connected to a first input terminal 592 of the fifth wire inductor 534 and a first output terminal 594 is connected to a second input terminal 700 of a sixth wire inductor 536. A second output terminal 598 of the fifth wire inductor 534 is connected to a first terminal of a second capacitor 540 and a second terminal of the second capacitor 540 is connected to the neutral line 510 to which the second terminal 582 of the fourth choke 530 is connected. The first terminal 580 of the fourth choke 530 is connected to the neutral line 510 of utility grid.

Third path is, from a third power line 508 connected to a first input terminal 560 of the third wire inductor 522 and a first output terminal 562 of the third wire inductor 522 is connected to a second input terminal 556 of the second wire inductor 520 and a second output terminal 558 of the second wire inductor 520 is connected to a first terminal 576 of a third choke 528 and a second terminal of the third choke 578 is connected to a first input terminal 704 of the sixth wire inductor 536 and a first output terminal 702 is connected to a second input terminal 588 of the fourth wire inductor 532. A second output terminal 706 of the sixth wire inductor 536 is connected to a first terminal of a first capacitor 538 and a second terminal of the first capacitor 538 is connected to the neutral line 510 to which the second terminal 582 of the fourth choke 530 is connected. The first terminal 580 of the fourth choke 530 is connected to the neutral line 510 of utility grid.

Fourth path is a series connection from the neutral line 510 of the utility grid to the first terminal 580 of the fourth choke 530, and the second terminal 582 of the fourth choke 530 is connected to the load circuit.

Embodiments in FIG. 3 and FIG. 4 can also be applied to a three phase delta system where the second terminals of capacitors are connected as shown in FIG. 2.

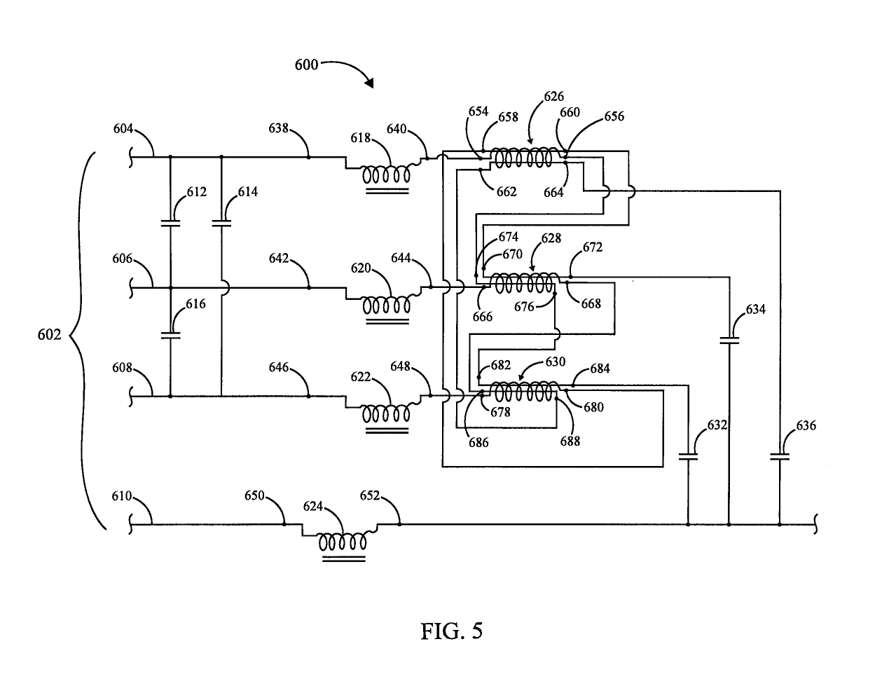

FIG. 5 is a schematic showing a configuration with wire inductor wound around two power lines, with six terminals. A first coupling capacitor 612 is connected across a first power line 604 and a second power line 606. A second coupling capacitor 614 is connected across the first power line 604 and a third power line 608, and a third coupling capacitor 616 is connected across the second power line 606 and the third power line 608.

First path is the first power line 604 from the parallel connection of first phase power line from the utility grid, connected to a first terminal 638 of a first choke 618 and a second terminal 640 is connected to a first input terminal 654 of a first wire inductor 626. A first output Terminal 656 of the first wire inductor 626 is connected to a third input terminal 674 of a second wire inductor 628. Then, a third output terminal 676 is connected to a second input terminal 682 of a third wire inductor 630, and a second output terminal 684 is connected to a first terminal of a first capacitor 632 and a second terminal of the first capacitor 632 is connected to a second terminal 652 of a fourth choke 624.

Second path is the second power line 606 from the parallel connection of second phase power line from the utility grid, connected to a first terminal 642 of a second choke 620 and a second terminal 644 is connected to a first input terminal 666 of the second wire inductor 628. A first output Terminal 668 of the second wire inductor 628 is connected to a third input terminal 686 of the third wire inductor 630. Then, a second output terminal 688 of the third wire inductor 630 is connected to a third input terminal 662 of the first wire inductor 626, and a third output terminal 664 is connected to a first terminal of a third capacitor 636 and a second terminal of the third capacitor 636 is connected to the second terminal 652 of the fourth choke 624.

Third path is the third power line 608 from the utility grid, connected to a first terminal 646 of a third choke 622 and a second terminal 648 connected to a first input terminal 678 of the third wire inductor 630. A first output terminal 680 of third wire inductor 630 is connected to a second input terminal 658 of the first wire inductor 626. Then, a third output terminal 688 of the third wire inductor 630 is connected to a third input terminal 662 of the first wire inductor 626, and a second output terminal 684 is connected to a first terminal of a first capacitor 632 and a second terminal of the first capacitor 632 is connected to the second terminal 652 of the fourth choke 624.

Fourth path is a series connection from the neutral line 610 of the utility grid to the first terminal 650 of the fourth choke 624, and the second terminal 652 of the fourth choke 624 is connected to the rest of the neutral line of the loads in the system.

Schematics of FIG. 5 can also be applied to a three phase delta system where the second terminal of capacitors 632, 634 and 636 are connected as shown in embodiment of FIG. 2.

This embodiment discloses that the magnetic fields created by windings of each power line can be used to regulate the current flowing on both its neighboring power lines.

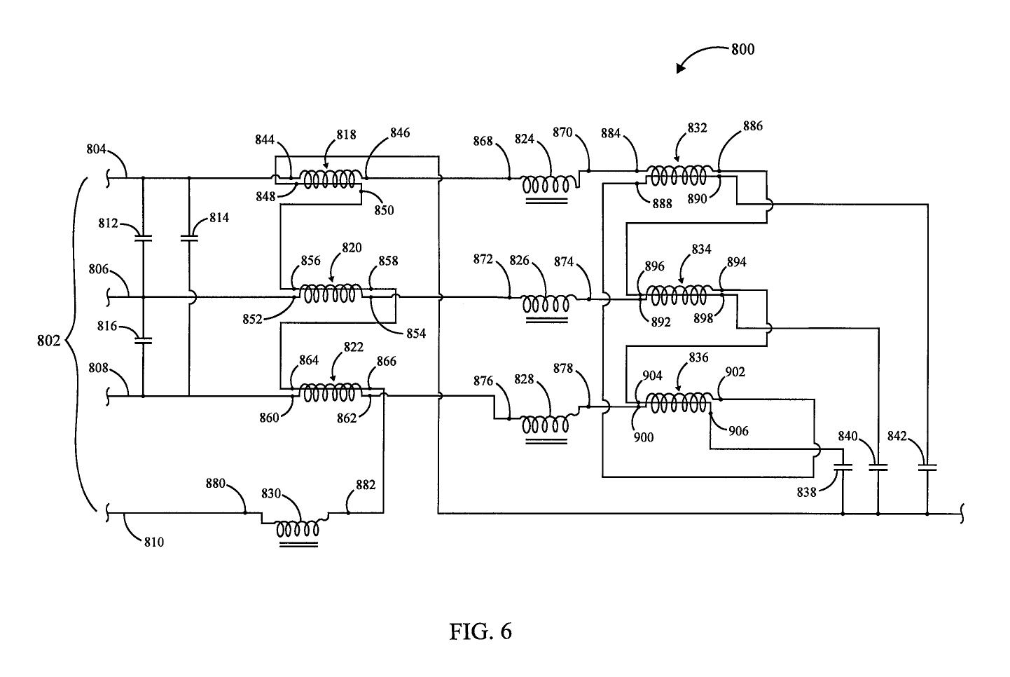

FIG. 6 is a schematic showing a configuration where the windings from each power line phases is around a neutral line 810. A first coupling capacitor 812 is connected across a first power line 804 and a second power line 806. A second coupling capacitor 814 is connected across the first power line 804 and a third power line 808 and a third coupling capacitor 816 is connected across the second power line 806 and the third power line 808.

First path is from the first power line 804 from the utility grid, connected to a first input terminal 844 of a first wire inductor 818 and a second output terminal 850 is connected to a second input terminal 856 of a second wire inductor 820. Then a second input terminal 848 of the first wire inductor 818 is connected to the rest of the loads in the system. The first output terminal 846 is connected a circuit following the schematic of FIG. 1, from the right side of a first terminal 138 of a first choke in FIG. 1.

Second path is from a second power line 806 from the utility grid, connected to a first input terminal 852 of a second wire inductor 820 and a second output terminal 858 is connected to a second input terminal 864 of a third wire inductor 822. Then a first output terminal 854 is connected to a circuit following the schematic of FIG. 1, from the right side of a first terminal 142 of a second choke in FIG. 1.

Third path is from third power line 808 from the utility grid, connected to a first input terminal 860 of a third wire inductor 822 and a second output terminal 866 of the third wire inductor 822 is connected to a second terminal 882 of a fourth choke 830. Then a first output terminal 862 is connected to a circuit following the schematic of FIG. 1, from the right side of a first terminal 146 of the third choke 122 in FIG. 1.

Fourth path is a series connection from a neutral line 810 of the utility grid to a first terminal 880 of the fourth choke 830, and the second terminal 882 of the fourth choke 830 is connected to the second output terminal 866 of the third wire inductor 822. The second input terminal 864 of the third wire inductor 822 is connected to the second output terminal 858 of the second wire inductor 820 and the second input terminal 856 is connected to the second output terminal 850 of the first wire inductor 818. The second input terminal 848 of the first wire inductor 818 is connected to the rest of the loads in the system.

The advantages of the present invention include, without limitation, a better balancing of the current among the three phase power lines, provide better power factor, and more efficient distribution of power in three phase system and saves energy.

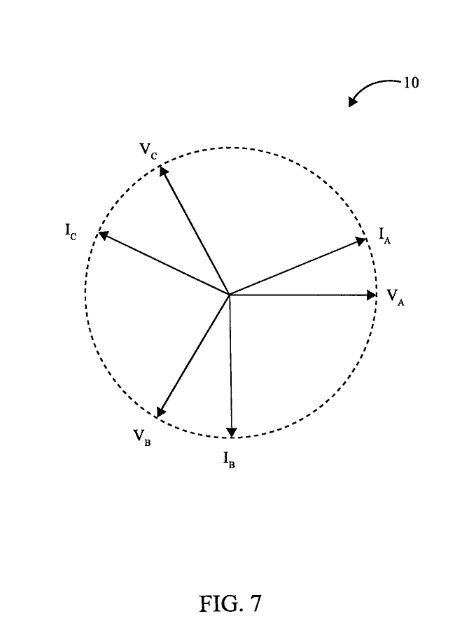

FIG. 7 shows the phasor diagram 10 showing the phase angle between voltages and currents in each phases of a three phase system without installing the alternating current power balancing system. From the figure, the current in each phase lags the respective voltages by a certain angle. This lag in current causes a low power factor in the system. The lower power factor will increase reactive power loss in the system. The phasors represents current in the first phase I_{A} which is lagging behind voltage of first phase V_{A}, current in the second phase I_{B} is lagging behind voltage of second phase V_{B}, current in the third phase I_{C} is lagging behind voltage of third phase V_{C}. These lagging currents cause major power loss in the electrical system.

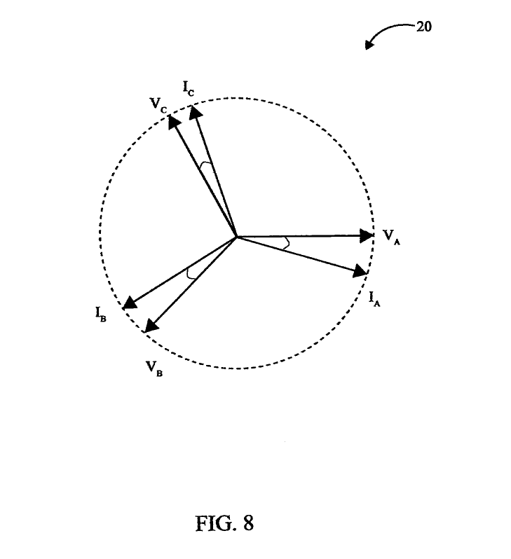

FIG. 8 shows a phasor diagram 20 showing the phase angle between voltages and currents in each phases of a three phase system with the alternating current power balancing system installed in the power grid. Angle between voltages in first phase V_{A}, second phase V_{B} and third phase V_{C} with respective currents I_{A}, I_{B} and I_{C} become less when the power balancing system is installed in the utility grid. This will improve the power factor of the system and thereby reduce power losses that might occur in the system devoid of the alternating current power balancing system.

The foregoing description of the preferred embodiment and alternate embodiments of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. An alternating current power balancing system for optimizing the consumption of power from a multiphase alternating current power source comprising:
a plurality of coupling capacitors, each being connected between each pair of a plurality of power lines from a power source;
a plurality of chokes each having a first terminal and a second terminal, each of the plurality of chokes being connected in series with each of the plurality of power lines;
a plurality of wire inductors being connected in series with each of the plurality of chokes; and
a plurality of capacitors connected between the plurality of inductors and at least one of the plurality of power lines;
whereby the plurality of power lines is made to carry balanced amount of currents through each line, improving power factor and thereby reducing amount of current returning to the power source.

2. The alternating current power balancing system of claim 1 wherein the plurality of coupling capacitors include a first coupling capacitor, a second coupling capacitor and a third coupling capacitor.

3. The alternating current power balancing system of claim 1 wherein the plurality of power lines include a first power line, a second power line, a third power line and a neutral line.

4. The alternating current power balancing system of claim 1 wherein the first coupling capacitor connected between the first power line and the second power line, the second coupling capacitor connected between the first power line and the third power line, the third coupling capacitor connected between the third power line and the second power line.

5. The alternating current power balancing system of claim 1 wherein the plurality of chokes having a first choke connected in series with the first power line, a second choke connected in series with the second power line, a third choke connected in series with the third power line and a fourth choke connected in series with the neutral line, the plurality of chokes reduces line harmonics and current spikes from the multiphase alternating current power source.

6. The alternating current power balancing system of claim 1 wherein the plurality of wire inductors has a winding wire wrapped tightly around an electrically isolated stand alone straight wire, the winding wire and the stand alone wire each having a pair of terminals.

7. The alternating current power balancing system of claim 1 wherein the plurality of wire inductors has four terminals, the four terminals include: a first input terminal, a second input terminal, a first output terminal and a second output terminal.

8. The alternating current power balancing system of claim 1 wherein the first terminal of each of the plurality of chokes is connected to each of the plurality of power lines and the second terminal of each of the plurality of chokes is connected to the first input terminal of each of the plurality of wire inductors.

9. The alternating current power balancing system of claim 1 wherein the plurality of capacitors is connected between at least one of the second output terminals of the plurality of wire inductors and the neutral line.

10. The alternating current power balancing system of claim 1 wherein at least one of the second output terminals of the plurality of wire inductors is connected to at least one of the second input terminals of the plurality of wire inductors.
